(19) United States
(12) Patent Application Publication
(10) Pub. No.: US 2024/0334186 A1
(43) Pub. Date: Oct. 3, 2024

(54) METHOD FOR UE-TO-NETWORK RELAY SECURITY IN PROXIMITY-BASED SERVICES

(71) Applicant: ZTE CORPORATION, Shenzhen (CN)

(72) Inventors: Yuze LIU, Shenzhen (CN); Shilin YOU, Shenzhen (CN); Zhen XING, Shenzhen (CN); Zhaoji LIN, Shenzhen (CN); Jigang WANG, Shenzhen (CN)

(73) Assignee: ZTE CORPORATION, Shenzhen (CN)

(21) Appl. No.: 18/625,371

(22) Filed: Apr. 3, 2024

Related U.S. Application Data
(63) Continuation of application No. PCT/CN2022/077089, filed on Feb. 21, 2022.

(51) Int. Cl. H04W 12/043; H04W 12/041; H04W 12/06; H04W 12/72; H04W 92/18

(52) U.S. Cl. CPC H04W 12/043; H04W 12/041; H04W 12/06; H04W 12/72; H04W 92/18

(57) ABSTRACT

Method, device and computer program product for wireless communication are provided. A method includes: receiving, by a proximity service anchor function from a remote wireless communication terminal, a request for a key used for a communication between the remote wireless communication terminal and a relay wireless communication terminal, and the request comprising at least one of: a Proximity Remote User Key, PRUK, identifier, an identifier of the remote wireless communication terminal, a relay service code, or a first nonce; and transmitting, by the proximity service anchor function to the remote wireless communication terminal, a request for the identity of the remote wireless communication terminal or a reject message in response to the proximity service anchor node not being able to find a PRUK stored locally corresponding to the PURK identifier or the proximity service anchor node determining to authenticate the remote wireless communication terminal.

### CROSS-REFERENCE TO RELATED PATENT APPLICATIONS

This application is a Continuation of PCT Application No. PCT/CN2022/077089, filed Feb. 21, 2022, incorporated herein by reference in its entirety.

### TECHNICAL FIELD

This document is directed generally to wireless communications, and in particular to 5^{th} generation (5G) communications.

### BACKGROUND

The 3GPP (the 3rd Generation Partnership Project) system should be able to authorize a UE (user equipment) to access the 5GC (5G core) network via a 5G UE-to-Network Relay and to authorize a UE to perform as a UE-to-Network Relay. Without a proper authorization, unauthorized entities will be able to access the 5GC via the UE-to-Network Relay or act as the UE-to-Network Relays creating a vulnerability and causing possible (D)DOS ((distributed) denial-of-service) attacks or leading to unauthorized service usage on both the 5GS (5G system) and the UE-to-Network Relay.

### SUMMARY

In some methods, a UE may generate a PRUK (Prose Remote User Key) ID after an authentication of a UE. The PRUK ID also can be used to access the network.

However, it is unclear how to use the PRUK ID to access the network.

One aspect of the present disclosure relates to a wireless communication method. In an embodiment, the wireless communication method includes: receiving, by a proximity service anchor function from a remote wireless communication terminal (e.g., via an Access and Mobility Management Function (AMF)), e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and transmitting, by the proximity service anchor function to the remote wireless communication terminal (e.g., via the AMF), e.g., via the relay wireless communication terminal, a request for the identity of the remote wireless communication terminal or a reject message in response to the proximity service anchor node not being able to find a PRUK stored locally corresponding to the PURK identifier or the proximity service anchor node determining to authenticate the remote wireless communication terminal.

Another aspect of the present disclosure relates to a wireless communication method. In an embodiment, the wireless communication method includes: receiving, by an authentication server function from a remote wireless communication terminal (e.g., via an AMF), e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and transmitting, by the authentication server function to the remote wireless communication terminal (e.g., via the AMF), e.g., via the relay wireless communication terminal, a request for the identity of the remote wireless communication terminal or a reject message in response to the authentication server function determining to authenticate the remote wireless communication terminal.

Another aspect of the present disclosure relates to a wireless communication method. In an embodiment, the wireless communication method includes: transmitting, by a remote wireless communication terminal to a proximity service anchor function (e.g., via an AMF), e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and receiving, by the remote wireless communication terminal to the proximity service anchor function (e.g., via the AMF), e.g., via the relay wireless communication terminal, a request for the identity of the remote wireless communication terminal or a reject message in response to the proximity service anchor node not being able to find a PRUK stored locally corresponding to the PURK identifier or the proximity service anchor node determining to authenticate the remote wireless communication terminal.

Another aspect of the present disclosure relates to a wireless communication method. In an embodiment, the wireless communication method includes: transmitting, by a remote wireless communication terminal to an authentication server function (e.g., via an AMF), e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and receiving, by the remote wireless communication terminal to the authentication server function (e.g., via the AMF), e.g., via the relay wireless communication terminal, a request for the identity of the remote wireless communication terminal or a reject message in response to the authentication server function determining to authenticate the remote wireless communication terminal.

Another aspect of the present disclosure relates to a wireless communication node. In an embodiment, the wireless communication node includes a communication unit and a processor. The processor is configured to: receive, by a proximity service anchor function from a remote wireless communication terminal, e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and transmit, by the proximity service anchor function to the remote wireless communication terminal, e.g., via the relay wireless communication terminal, a request for the identity of the remote wireless communication terminal or a reject message in response to the proximity service anchor node not being able to find a PRUK stored locally corresponding to the PRUK identifier or the proximity service anchor node determining to authenticate the remote wireless communication terminal.

Another aspect of the present disclosure relates to a wireless communication node. In an embodiment, the wireless communication node includes a communication unit and a processor. The processor is configured to: receive, by an authentication server function from a remote wireless communication terminal, e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and transmit, by the authentication server function to the remote wireless communication terminal, e.g., via the relay wireless communication terminal, a request for the identity of the remote wireless communication terminal or a reject message in response to the authentication server function determining to authenticate the remote wireless communication terminal.

Another aspect of the present disclosure relates to a remote wireless communication terminal. In an embodiment, the remote wireless communication terminal includes a communication unit and a processor. The processor is configured to: transmit, to a proximity service anchor function, e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and receive, to the proximity service anchor function, e.g., via the relay wireless communication terminal a request for the identity of the remote wireless communication terminal or a reject message in response to the proximity service anchor node not being able to find a PRUK stored locally corresponding to the PURK identifier or the proximity service anchor node determining to authenticate the remote wireless communication terminal.

Another aspect of the present disclosure relates to a remote wireless communication terminal. In an embodiment, the remote wireless communication terminal includes a communication unit and a processor. The processor is configured to: transmit, to an authentication server function, e.g., via a relay wireless communication terminal, a request for a key used for a communication between the remote wireless communication terminal and the relay wireless communication terminal, and the request comprising at least one of: a Proximity Remote User Key, PRUK, identifier, an identifier of the remote wireless communication terminal, a relay service code, or a first nonce; and receive, to the authentication server function, e.g., via the relay wireless communication terminal, a request for the identity of the remote wireless communication terminal or a reject message in response to the authentication server function determining to authenticate the remote wireless communication terminal.

Various embodiments may preferably implement the following features:

Preferably or in some embodiments, the reject message comprises a value indicating a reject reason indicating the remote wireless communication terminal to use the identity of the remote wireless communication terminal to request the key used for the communication between the remote wireless communication terminal and the relay wireless communication terminal.

Preferably or in some embodiments, the identity of the remote wireless communication terminal comprises a Subscription Concealed Identifier, SUCI, of the remote wireless communication terminal.

Preferably or in some embodiments, the proximity service anchor function selects an Authentication Server Function, AUSF, according to at least one of the identity of the remote wireless communication terminal or the PRUK identifier, and transmits an authentication request to the selected AUSF.

Preferably or in some embodiments, the proximity service anchor function receives an authentication response from the selected AUSF and transmits the key to a relay wireless communication terminal according to the authentication response.

Preferably or in some embodiments, the proximity service anchor function generates the key according to the PRUK in the authentication response.

Preferably or in some embodiments, the proximity service anchor function generates the key according to the PRUK stored locally corresponding to the PURK identifier.

Preferably or in some embodiments, the authentication server function transmits the request for generating the key to a proximity service anchor function, PAnF.

Preferably or in some embodiments, the authentication server function discovers the PAnF according to the PRUK identifier.

Preferably or in some embodiments, the request for generating the key comprises at least one of: the PRUK identifier, a PURK, and the identity of the remote wireless communication terminal.

Preferably or in some embodiments, the authentication server function transmits the request for the key to a proximity service anchor function, PAnF, in response to the authentication server function determining not to authenticate the remote wireless communication terminal.

Preferably or in some embodiments, the authentication server function transmits, to the remote wireless communication terminal, the request for the identity of the remote wireless communication terminal or the reject message in response to receiving a response from the PAnF indicating that the PAnF is not able to retrieve the key.

Preferably or in some embodiments, the remote wireless communication terminal transmits, to the proximity service anchor function, a new request for the key comprising the identity of the remote wireless communication terminal according to the request for the identity of the remote wireless communication terminal or the reject message.

Preferably or in some embodiments, the remote wireless communication terminal transmits, to the authentication server function, a new request for the key comprising the identity of the remote wireless communication terminal according to the request for the identity of the remote wireless communication terminal or the reject message.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example 5G system architecture.

FIG. 2 shows an example security procedure over control plane.

FIG. 3 shows a schematic diagram of a wireless terminal according to an embodiment of the present disclosure.

FIG. 4 shows a schematic diagram of a wireless network node according to an embodiment of the present disclosure.

FIG. 5 shows a method for a security procedure over control plane according to an embodiment of the present disclosure.

FIG. 6 shows a method for a security procedure over control plane according to an embodiment of the present disclosure.

FIG. 7 shows a method for a security procedure over control plane according to an embodiment of the present disclosure.

FIG. 8 shows a method for a security procedure over control plane according to an embodiment of the present disclosure.

FIG. 9 shows a method for a security procedure over control plane according to an embodiment of the present disclosure.

FIG. 10 shows a method for a security procedure over control plane according to an embodiment of the present disclosure.

### DETAILED DESCRIPTION

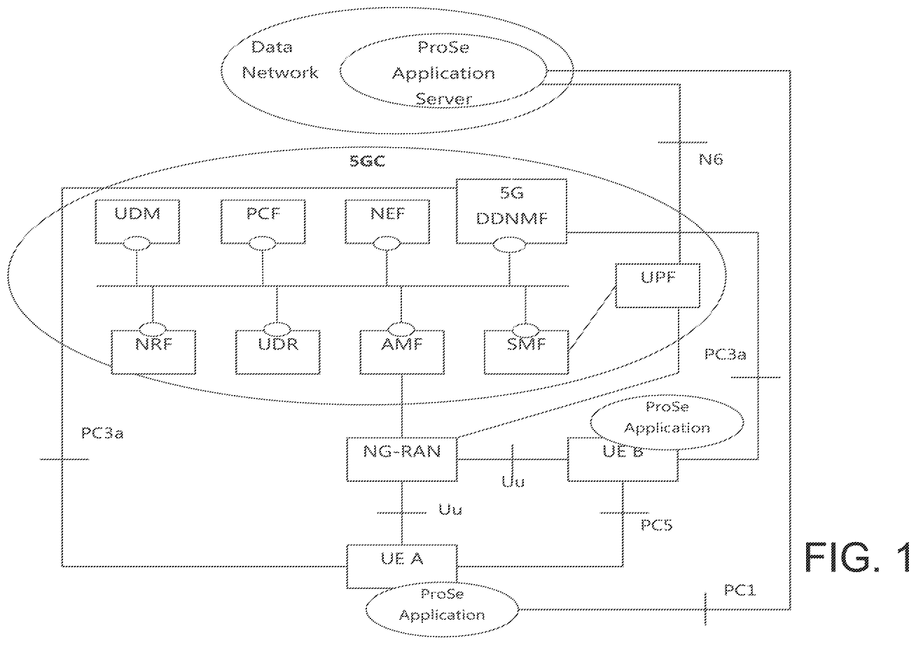

FIG. 1 shows an example 5G system architecture.

In the architecture of FIG. 1, the 5G Direct Discovery Name Management Function (DDNMF) is introduced. The 5G DDNMF has similar functions from an architecture point of view to those of the DDNMF part of ProSe Function.

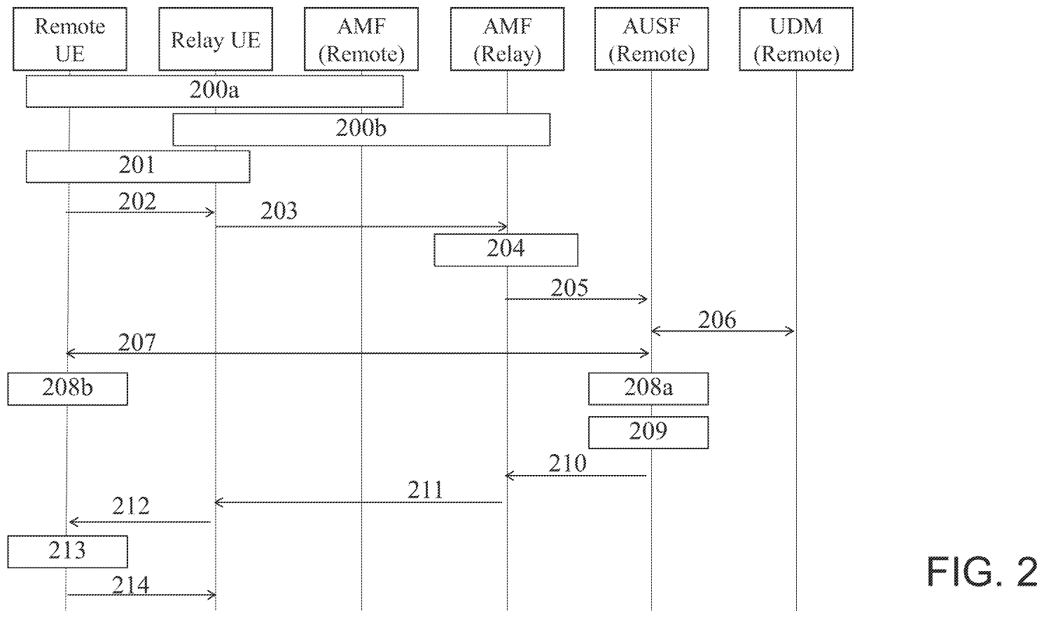

FIG. 2 shows an example security procedure over control plane. The procedure includes:
Steps 200a, 200b: the remote UE and the relay UE may be registered with the network. The UE-to-Network relay may be authenticated and authorized by the network to support as a relay UE. The remote UE may be authenticated and authorized by the network to act as a remote UE.
Step 201: the remote UE may initiate discovery procedure using any method (e.g., Model A or Model B method).
Step 202: after the discovery of the UE-to-Network relay, the remote UE may send a Direct Communication Request (DCR) to the relay UE for establishing a secure PC5 unicast link. The remote UE may include its security capabilities and security policy in the DCR message. The message may also include a SUCI, a Relay Service Code, and/or a nonce Nonce_1.
Step 203: upon receiving the DCR message, the relay UE may send the relay key request to the relay AMF, including the parameters received in the DCR message.
Step 204: the Relay AMF may verify whether the relay UE is authorized to act as a U2N (UE to Network) relay.
Step 205: the relay AMF may select an AUSF based on the SUCI and forward the key request to the AUSF in Nausf_UEAuthentication_Authenticate Request message.
Step 206: the AUSF may retrieve the Authentication Vectors from the UDM.
Step 207: the AUSF may trigger the primary authentication of the remote UE. This authentication is performed between the AUSF and the remote UE via the relay AMF and the relay UE. The AUSF may not make the newly derived K_{AUSF} as the latest K_{AUSF}. At the remote UE, the newly derived K_{AUSF} may not be taken as latest K_{AUSF} as the NAS (Non-Access-Stratum) SMC (Security Mode Command) procedure is not performed between the remote UE and the relay AMF.
Steps 208a, 208b: based on the successful primary authentication, the AUSF and remote UE may generate 5GPRUK and 5GPRUK using the newly derived K_{AUSF}.
Step 209: the AUSF may generate the K_{NR_ProSe} key.
Step 210: the AUSF may send the 5GPRUK ID, K_{NR_ProSe}, a nonce Nonce_2 in an Nausf_UEAuthentication_Authenticate Response message to the UE-to-Network relay via the relay AMF.
Step 211: when receiving a K_{NR_ProSe} from AUSF, the AMF may not attempt to trigger the NAS SMC procedure with the remote UE. The relay UE derives a PC5 session key K_{relay-sess} and confidentiality and integrity keys from the K_{NR_ProSe}, using the KDF (Key Distribution Function). The K_{NR_ProSe} ID and K_{relay-sess} ID are established in the same way as the K_{NRP} ID and K_{NRP-sess} ID.
Step 212: the UE-to-Network relay may send the received 5GPRUK ID and Nonce_2 to the remote UE in the Direct Security mode command message.
Step 213: the remote UE may use the 5GPRUK ID to locate the K_{AUSF}/5GPRUK to be used for the PC5 link security. The remote UE may generate the K_{NR_ProSe} key to be used for Remote access via the relay UE. The remote UE may derive a PC5 session key K_{relay-sess} and confidentiality and integrity keys from the K_{NR_ProSe}.
Step S214: the remote UE may send the Direct Security mode complete message to the UE-to-Network relay.

Further communication between the remote UE and the network takes place securely via the UE-to-Network relay.

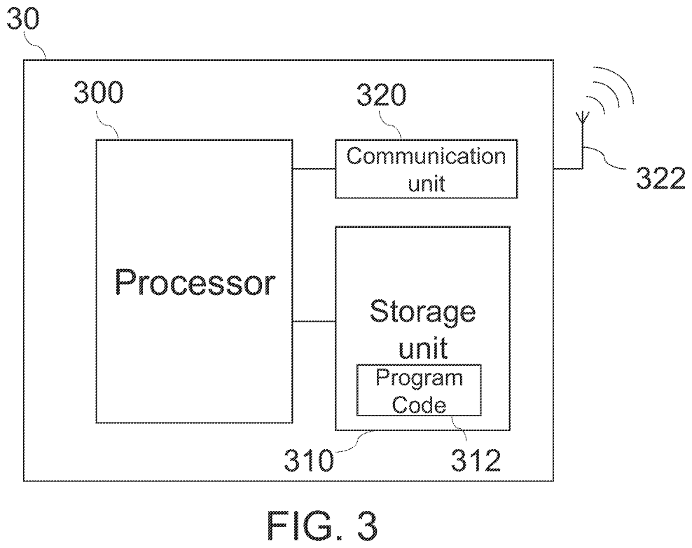

FIG. 3 relates to a schematic diagram of a wireless terminal 30 according to an embodiment of the present disclosure. The wireless terminal 30 may be a user equipment (UE), a mobile phone, a relay wireless communication terminal, a remote wireless communication terminal, a laptop, a tablet computer, an electronic book or a portable computer system and is not limited herein. The wireless terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage unit 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 520 transmits and receives the signals via at least one antenna 322 shown in FIG. 3.

In an embodiment, the storage unit 310 and the program code 312 may be omitted and the processor 300 may include a storage unit with stored program code.

The processor 300 may implement any one of the steps in exemplified embodiments on the wireless terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless network node (e.g., a base station).

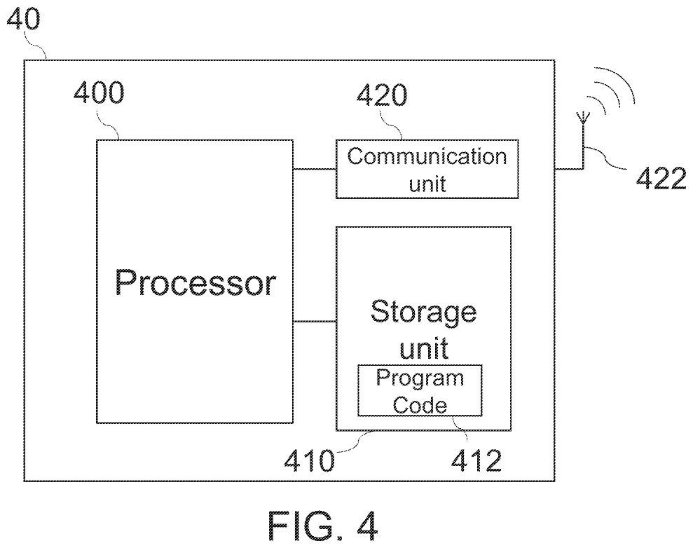

FIG. 4 relates to a schematic diagram of a wireless network node 40 according to an embodiment of the present disclosure. The wireless network node 40 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 60 may comprise (perform) at least one network function such as an access and mobility management function (AMF), a session management function (SMF), a user place function (UPF), a policy control function (PCF), an application function (AF), a PAnF, a AUSF, etc. The wireless network node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422 shown in FIG. 4.

In an embodiment, the storage unit 410 and the program code 412 may be omitted. The processor 400 may include a storage unit with stored program code.

The processor 400 may implement any steps described in exemplified embodiments on the wireless network node 40, e.g., via executing the program code 412.

The communication unit 420 may be a transceiver. The communication unit 420 may as an alternative or in addition be combining a transmitting unit and a receiving unit configured to transmit and to receive, respectively, signals to and from a wireless terminal (e.g., a user equipment or another wireless network node).

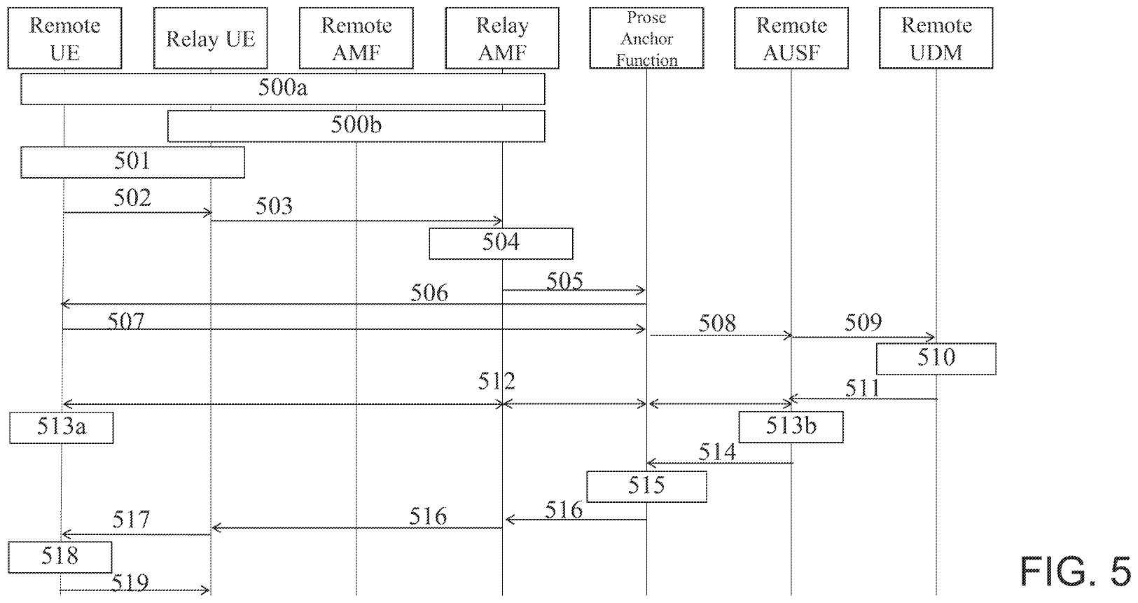

In an embodiment, there is provided a method for a security procedure over control plane as shown in FIG. 5. The method comprises the following steps:
Steps 500a, 500b: the remote UE and the relay UE are registered with the network. The UE-to-Network relay is authenticated and authorized by the network to support as a relay UE. The remote UE is authenticated and authorized by the network to act as a remote UE.
Step 501: the remote UE initiates discovery procedure.
Step 502: after the discovery of the UE-to-Network relay, the remote UE sends a Direct Communication Request to the relay UE for establishing a secure PC5 unicast link. The remote UE includes its security capabilities and security policy in the DCR message. The message also includes a SUCI, a 5GPRUK ID if available, a Relay Service Code, a nonce Nonce_1.
Step 503: upon receiving the DCR message, the relay UE sends the relay key request to the relay AMF, including the parameters received in the DCR message.
Step 504: the Relay AMF verifies whether the relay UE is authorized to act as a U2N relay.
Step 505: the Relay AMF selects a PAnF based on the SUCI or 5GPRUK ID and forwards the key request to the PAnF in an Npanf_ProseKey_Request message. The relay AMF also includes the serving network name in the key request.

If 5GPRUK ID is received from the relay AMF, the PAnF discovers the 5G PRUK stored locally for the remote UE and the procedure goes to step 215. Otherwise, the PAnF continues with the following steps.
Step 506: if the remote UE uses 5G PRUK ID, but the PAnF cannot discover the 5G PRUK accordingly, or the PAnF decides to authenticate the remote UE based on its local policy, the PAnF requests the UE identity from the remote UE via the relay AMF and relay UE.
Step 507: the remote UE sends a response comprising its identity (e.g., SUCI) to the PAnF via the relay AMF and relay UE.
Step 508: the PAnF may select a Remote AUSF (e.g., an AUSF serving the remote UE) and send the authentication request to the AUSF in an Nausf_UEAuthentication_ProseAuthenticate Request message.
Step 509: the Remote AUSF may retrieve the Authentication Vectors (AV) from the UDM via Nudm_UEAuthentication_GetProseAv Request message.
Step 510: the Remote UDM de-conceals the SUCI and generates the AV.
Step 511: the Remote AUSF receives a response from the Remote UDM comprising the Authentication Vectors (AV) from the UDM via an Nudm_UEAuthentication_GetProseAV Response message.
Step 512: the Remote AUSF triggers an authentication of the remote UE. This authentication is performed between the AUSF and the remote UE via the relay AMF and relay UE. The AUSF may not make the newly derived key K_{AUSF} as the latest key K_{AUSF}. At the remote UE, the newly derived K_{AUSF} is not taken as the latest K_{AUSF} as the NAS SMC procedure is not performed between the remote UE and relay AMF.
Step 513a to 513b: based on a successful primary authentication, the AUSF and remote UE generate the 5GPRUK and 5GPRUK ID using the newly derived K_{AUSF}.
Step 514: the AUSF sends the SUPI, 5GPRUK, 5GPRUK ID in an Nausf_UEAuthentication_ProseAuthenticate Response message to the PAnF.
Step 515: the PAnF stores the Prose context information (i.e., SUPI, 5GPRUK, 5GPRUK ID) for the remote UE and generate a nonce Nonce_2 and the K_{NR_ProSe} key.
Step 516: the PAnF sends the K_{NR_ProSe} key, the Nonce_2 in an Npanf_ProseKey_Response message to the UE-to-Network relay via the relay AMF. When receiving a K_{NR_ProSe} from the PAnF, the AMF may not attempt to trigger the NAS SMC procedure with the remote UE. The relay UE derives the PC5 session key K_{relay-sess} and confidentiality and integrity keys from the K_{NR_ProSe}, using the KDF (Key Distribution Function). The K_{NR_ProSe} ID and K_{relay-sess} ID are established in the same way as the K_{NRP} ID and K_{NRP-sess} ID.
Step 517: the UE-to-Network relay sends the received Nonce_2 to the remote UE in the Direct Security mode command message.
Step 518: the remote UE generates the K_{NR_ProSe} key to be used for Remote access via the relay UE. The remote UE derives the PC5 session key K_{relay-sess} and confidentiality and integrity keys from the K_{NR_ProSe}.
Step 519: the remote UE sends the Direct Security mode complete message to the UE-to-Network relay.

Further communication between the remote UE and the network takes place securely via the UE-to-Network relay.

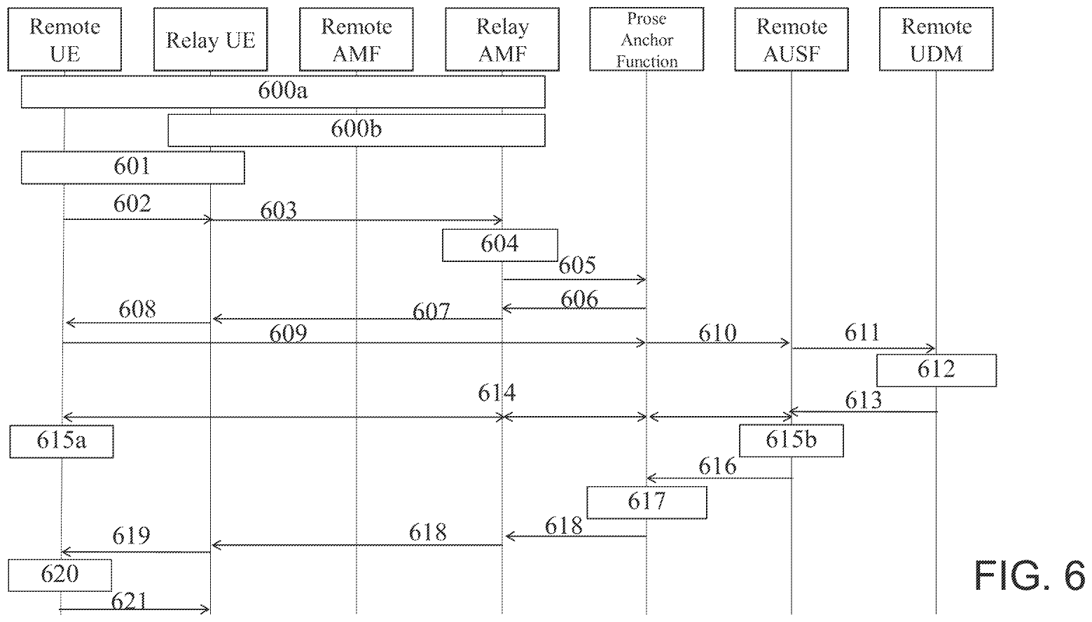

In an embodiment, there is provided a method for a security procedure over control plane as shown in FIG. 6. The method comprises the following steps:
Steps 600a to 600b: the remote UE and the relay UE are registered with the network. The UE-to-Network relay is authenticated and authorized by the network to support as a relay UE. The remote UE is authenticated and authorized by the network to act as a remote UE.
Step 601: the remote UE initiates a discovery procedure.
Step 602: after the discovery of the UE-to-Network relay, the remote UE sends a Direct Communication Request to the relay UE for establishing a secure PC5 unicast link. The remote UE includes its security capabilities and security policy in the DCR message. The message also includes a SUCI, a 5GPRUK ID if available, a Relay Service Code, a Nonce_1.
Step 603: upon receiving the DCR message, the relay UE sends the relay key request to the relay AMF, including the parameters received in the DCR message.
Step 604: the Relay AMF verifies whether the relay UE is authorized to act as an U2N relay.
Step 605: the Relay AMF selects a PAnF based on the SUCI or 5GPRUK ID and forwards the key request to the PAnF in Npanf_ProseKey_Request message. The relay AMF also includes the serving network name in the key request.

If the 5GPRUK ID is received from the relay AMF, the PAnF discovers the 5G PRUK stored locally for the remote UE and go to step 617. Otherwise, the PAnF continues with the following steps.
Step 606 to 608: if the remote UE uses the 5G PRUK ID, but the PAnF cannot discover the 5G PRUK accordingly, or the PAnF decides to authenticate the remote UE based on its local policy, the PAnF sends a reject message, e.g., an Nausf_PorseKey Reject, to the UE via the relay AMF and relay UE. The reject message may include a value to indicate the reject reason.
Step 609: the UE uses its identity (SUCI) to retry steps 602 to 605.
Step 610: the PAnF selects the Remote AUSF and sends an authentication request to the Remote AUSF in the Nausf_UEAuthentication_ProseAuthenticate Request message.
Step 611: the AUSF retrieves the Authentication Vectors from the UDM via the Nudm_UEAuthentication_GetProseAv Request message and triggers an authentication of the remote UE.
Step 612: the Remote UDM de-conceals the SUCI and generates the AV.
Step 613: the Remote AUSF receives a response from the Remote UDM comprising the Authentication Vectors (AV) from the UDM via the Nudm_UEAuthentication_GetProseAV Response message.
Step 614: the remote UE is authenticated. This authentication is performed between the AUSF and the remote UE via the relay AMF and the relay UE. The AUSF does not make the newly derived K_{AUSF} as the latest K_{AUSF}. At the remote UE, the newly derived K_{AUSF} is not taken as the latest K_{AUSF} as the NAS SMC procedure is not performed between the remote UE and the relay AMF.
Step 615a to 615b: based on a successful primary authentication, the AUSF and remote UE may generate the 5GPRUK and 5GPRUK ID using the newly derived K_{AUSF}.
Step 614: the AUSF sends the SUPI, 5GPRUK, 5GPRUK ID in the Nausf_UEAuthentication_ProseAuthenticate Response message to the PAnF.
Step 617: the PAnF stores the Prose context information (i.e., SUPI, 5GPRUK, 5GPRUK ID) for the remote UE and generates the Nonce_2 and the K_{NR_ProSe} key.
Step 618: the PAnF sends the K_{NR_ProSe} key, the Nonce_2 in the Npanf_ProseKey_Response message to the UE-to-Network relay via the relay AMF. When receiving a K_{NR_ProSe} from the PAnF, the AMF may not attempt to trigger the NAS SMC procedure with the remote UE. The relay UE derives the PC5 session key K_{relay-sess} and confidentiality and integrity keys from the K_{NR_ProSe}, using the KDF. The K_{NR_ProSe} ID and K_{relay-sess} ID are established in the same way as the K_{NRP} ID and K_{NRP-sess} ID.
Step 619: the UE-to-Network relay sends the received Nonce_2 to the remote UE in the Direct Security mode command message.
Step 620: the remote UE generates the K_{NR_ProSe} key to be used for Remote access via the relay UE. The remote UE derives the PC5 session key K_{relay-sess} and confidentiality and integrity keys from the K_{NR_ProSe}.
Step 621: the remote UE sends the Direct Security mode complete message to the UE-to-Network relay.

Further communication between the remote UE and the Network takes place securely via the UE-to-Network relay.

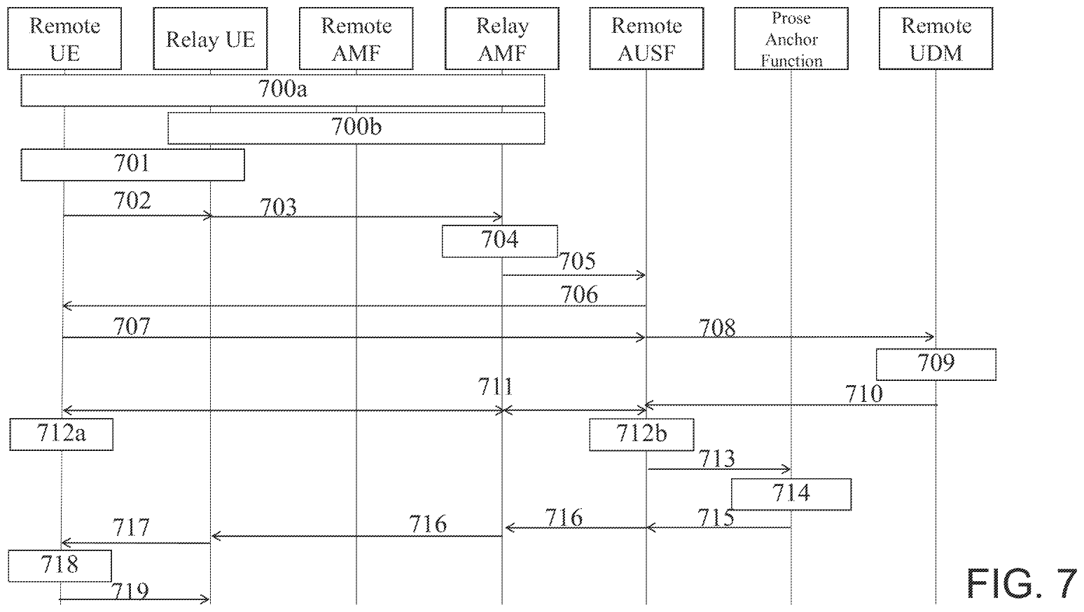

In an embodiment, there is provided a method for a security procedure over control plane as shown in FIG. 7. The method comprises the following steps:
Steps 700a to 700b: the remote UE and the relay UE are registered with the network. The UE-to-Network relay is authenticated and authorized by the network to support as a relay UE. The remote UE is authenticated and authorized by the network to act as a remote UE.
Step 701: the remote UE initiates a discovery procedure.
Step 702: after the discovery of the UE-to-Network relay, the remote UE sends a Direct Communication Request to the relay UE for establishing a secure PC5 unicast link. The remote UE includes its security capabilities and security policy in the DCR message. The message also includes a SUCI (or a PRUK ID), a Relay Service Code, and a nonce Nonce_1.
Step 703: upon receiving the DCR message, the relay UE sends the relay key request to the relay AMF, including the parameters received in the DCR message.
Step 704: the Relay AMF verifies whether the relay UE is authorized to act as an U2N relay.
Step 705: the Relay AMF selects AUSF based on SUCI or PRUK ID and forwards the key request to the AUSF in the Nausf_UEAuthentication_Authenticate Request message. The relay AMF also includes the serving network name in the key request. If the SUCI is received from the relay AMF, the procedure goes to step 708.
Step 706: if the remote UE uses the 5G PRUK ID, but the AUSF decides to authenticate the remote UE based on its local policy, the AUSF requests the UE identity from the remote UE via the relay AMF and the relay UE.
Step 707: the remote UE sends a response including its identity (SUCI) to the AUSF via the relay AMF and the relay UE.
Step 708: the AUSF retrieves the Authentication Vectors from the UDM via the Nudm_UEAuthentication_GetProseAv Request message and triggers an authentication of the remote UE.
Step 709: the Remote UDM de-conceals the SUCI and generates the AV.
Step 710: the Remote AUSF receives a response from the Remote UDM comprising the Authentication Vectors (AV) from the UDM via the Nudm_UEAuthentication_GetProseAV Response message.
Step 711: the remote UE is authenticated. This authentication is performed between the AUSF and the remote UE via the relay AMF and relay UE. The AUSF does not make the newly derived K_{AUSF} as the latest K_{AUSF}. At the remote UE, the newly derived K_{AUSF} is not taken as the latest K_{AUSF} as the NAS SMC procedure is not performed between the remote UE and the relay AMF.
Step 712a to 712b: based on a successful primary authentication, the AUSF and remote UE may generate the 5GPRUK and 5GPRUK ID using the newly derived K_{AUSF}.
Step 713: the AUSF sends the t SUPI, 5GPRUK, 5GPRUK ID in Npanf_ProseAnchorKey_Register Response message to the PAnF.
Step 714: the PAnF stores the Prose context information (i.e., SUPI, 5GPRUK, 5GPRUK ID) for the remote UE and generates Nonce_2 and the K_{NR_ProSe} key.
Step 715 to 716: the PAnF sends the K_{NR_ProSe} key, the Nonce_2 in Npanf_ProseKey_Response message to the UE-to-Network relay via the relay AMF. When receiving a K_{NR_ProSe} from the PAnF, via the AUSF, the AMF may not attempt to trigger the NAS SMC procedure with the remote UE. The relay UE derives the PC5 session key K_{relay-sess} and confidentiality and integrity keys from the K_{NR_ProSe}, using the KDF. The K_{NR_ProSe} ID and K_{relay-sess} ID are established in the same way as the K_{NRP} ID and K_{NRP-sess} ID.
Step 717: the UE-to-Network relay sends the received Nonce_2 to the remote UE in the Direct Security mode command message.
Step 718: the remote UE generates the K_{NR_ProSe} key to be used for Remote access via the relay UE. The remote UE derives the PC5 session key K_{relay-sess} and confidentiality and integrity keys from the K_{NR_ProSe}.
Step 719: the remote UE sends the Direct Security mode complete message to the UE-to-Network relay.

Further communication between the remote UE and the Network takes place securely via the UE-to-Network relay.

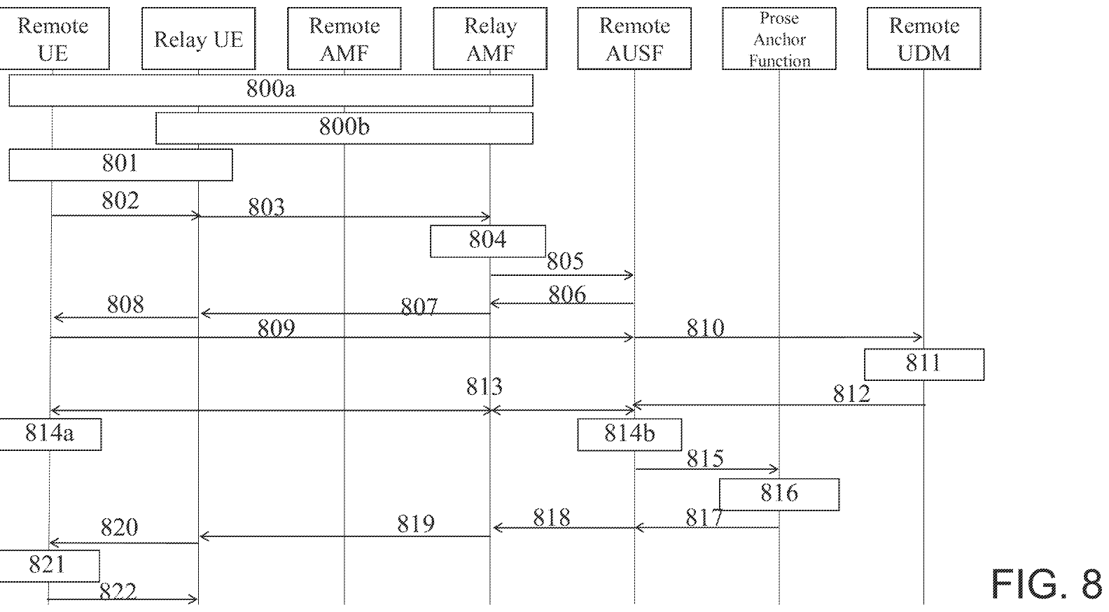

In an embodiment, there is provided a method for a security procedure over control plane as shown in FIG. 8. The method comprises the following steps:
Steps 800a to 800b: the remote UE and the relay UE are registered with the network. The UE-to-Network relay is authenticated and authorized by the network to support as a relay UE. The remote UE is authenticated and authorized by the network to act as a remote UE.
Step 801: the remote UE initiates a discovery procedure.
Step 802: after the discovery of the UE-to-Network relay, the remote UE sends a Direct Communication Request to the relay UE for establishing a secure PC5 unicast link. The remote UE includes its security capabilities and security policy in the DCR message. The message also includes a SUCI (or a PRUK ID), a Relay Service Code, and a nonce Nonce_1.
Step 803: upon receiving the DCR message, the relay UE sends the relay key request to the relay AMF, including the parameters received in the DCR message.
Step 804: the Relay AMF verifies whether the relay UE is authorized to act as an U2N relay.
Step 805: the Relay AMF selects AUSF based on SUCI or PRUK ID and forwards the key request to the AUSF in Nausf_UEAuthentication_Authenticate Request message. The relay AMF also includes the serving network name in the key request. If the SUCI is received from the relay AMF, the procedure goes to step 810.
Steps 806 to 808: if the remote UE uses the 5G PRUK ID, but the AUSF decides to authenticate the remote UE based on its local policy, the AUSF sends a reject message to UE via the relay AMF and the relay UE. The reject message may include a value to indicate the reject reason.
Step 809: the UE uses its identity (SUCI) to retry steps 802 to 805.
Step 810: the AUSF retrieves the Authentication Vectors from the UDM via Nudm_UEAuthentication_GetProseAv Request message and triggers an authentication of the remote UE.
Step 811: the Remote UDM de-conceals the SUCI and generates the AV.
Step 812: the Remote AUSF receives a response from the Remote UDM comprising the Authentication Vectors (AV) from the UDM via Nudm_UEAuthentication_GetProseAV Response message.
Step 813: the remote UE is authenticated. This authentication is performed between the AUSF and the remote UE via the relay AMF and relay UE. The AUSF does not make the newly derived K_{AUSF} as the latest K_{AUSF}. At the remote UE, the newly derived K_{AUSF} is not taken as the latest K_{AUSF} as the NAS SMC procedure is not performed between the remote UE and the relay AMF.
Step 814a to 814b: based on a successful primary authentication, the AUSF and remote UE may generate the 5GPRUK and 5GPRUK ID using the newly derived K_{AUSF}.
Step 815: the AUSF sends the SUPI, 5GPRUK, 5GPRUK ID in Nausf_UEAuthentication_ProseAuthenticate Response message to the PAnF.
Step 816: the PAnF stores the Prose context information (i.e., SUPI, 5GPRUK, 5GPRUK ID) for the remote UE and generates the Nonce_2 and the K_{NR_ProSe} key.
Step 817 to 819: the PAnF sends the K_{NR_ProSe} key, the Nonce_2 in Npanf_ProseKey_Response message to the UE-to-Network relay via the relay AMF. When receiving a K_{NR_ProSe} from the PAnF, via the AUSF, the AMF may not attempt to trigger the NAS SMC procedure with the remote UE. The relay UE derives the PC5 session key K_{relay-sess} and confidentiality and integrity keys from the K_{NR_ProSe}, using the KDF. The K_{NR_ProSe} ID and K_{relay-sess} ID are established in the same way as the K_{NRP} ID and K_{NRP-sess} ID.
Step 820: the UE-to-Network relay sends the received Nonce_2 to the remote UE in the Direct Security mode command message.
Step 821: the remote UE generates the K_{NR_ProSe} key to be used for Remote access via the relay UE. The remote UE derives the PC5 session key K_{relay-sess} and confidentiality and integrity keys from the K_{NR_ProSe}.
Step 822: the remote UE sends the Direct Security mode complete message to the UE-to-Network relay.

Further communication between the remote UE and the Network takes place securely via the UE-to-Network relay.

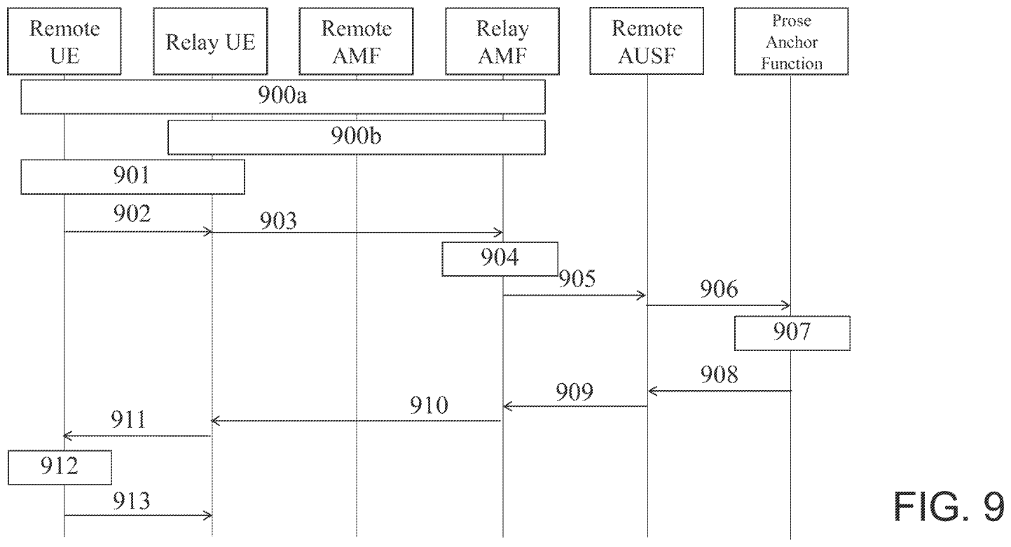

In an embodiment, there is provided a method for a security procedure over control plane as shown in FIG. 9. The method comprises the following steps:
Steps 900a to 900b: the remote UE and the relay UE are registered with the network. The UE-to-Network relay is authenticated and authorized by the network to support as a relay UE. The remote UE is authenticated and authorized by the network to act as a remote UE.
Step 901: the remote UE initiates a discovery procedure.
Step 902: after the discovery of the UE-to-Network relay, the remote UE sends a Direct Communication Request to the relay UE for establishing a secure PC5 unicast link. The remote UE includes its security capabilities and security policy in the DCR message. The message also includes the SUCI, Relay Service Code and Nonce_1.
Step 903: upon receiving the DCR message, the relay UE sends the relay key request to the relay AMF, including the parameters received in the DCR message.
Step 904: the Relay AMF verifies whether the relay UE is authorized to act as an U2N relay.
Step 905: the Relay AMF selects AUSF based on SUCI and forwards the key request to the AUSF in Nausf_UEAuthentication_Authenticate Request message. The relay AMF also includes the serving network name in the key request.
Step 906: if 5GPRUK ID is received from the relay AMF, the AUSF decides not to trigger authentication of UE and the AUSF discovers the PAnF based on the 5G PRUK ID. The AUSF sends a Npanf_Prose_AnchorKey_Get Request message to the PAnF. The 5G PRUK ID is included in this message.
Step 907: the PAnF retrieves the Prose context information (i.e., SUPI, 5GPRUK, 5GPRUK ID) for the remote UE and generate Nonce_2 and the K_{NR_ProSe} key.
Step 908 to 910: the PAnF sends the K_{NR_ProSe} key and the Nonce_2 in Npanf_ProseKey_Response message to the UE-to-Network relay via the relay AMF. When receiving a K_{NR_ProSe} from the PAnF, via the AUSF, the AMF may not attempt to trigger the NAS SMC procedure with the remote UE. The relay UE derives the PC5 session key K_{relay-sess} and confidentiality and integrity keys from the K_{NR_ProSe}, using the KDF. The K_{NR_ProSe} ID and K_{relay-sess} ID are established in the same way as the K_{NRP} ID and K_{NRP-sess} ID.
Step 911: the UE-to-Network relay sends the received Nonce_2 to the remote UE in the Direct Security mode command message.
Step 912: the remote UE generates the K_{NR_ProSe} key to be used for Remote access via the relay UE. The remote UE derives the PC5 session key K_{relay-sess} and confidentiality and integrity keys from the K_{NR_ProSe}.
Step 913: the remote UE sends the Direct Security mode complete message to the UE-to-Network relay.

Further communication between the remote UE and the Network takes place securely via the UE-to-Network relay.

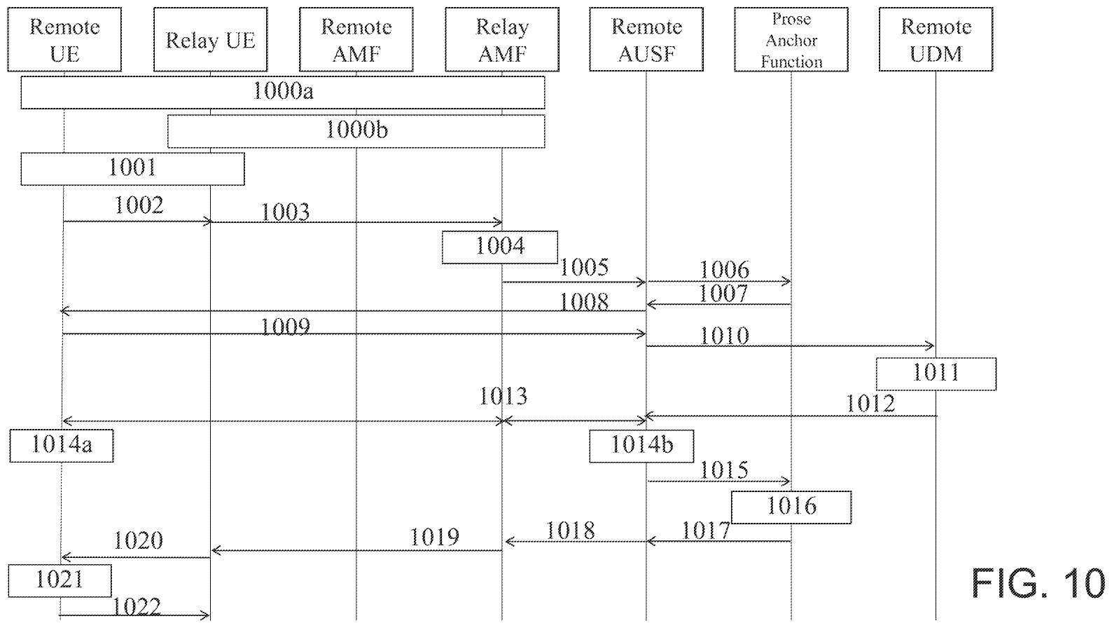

In an embodiment, there is provided a method for a security procedure over control plane as shown in FIG. 10. The method comprises the following steps:
Steps 1000a to 1000b: the remote UE and the relay UE are registered with the network. The UE-to-Network relay is authenticated and authorized by the network to support as a relay UE.

The remote UE is authenticated and authorized by the network to act as a remote UE.
Step 1001: the remote UE initiates a discovery procedure.
Step 1002: after the discovery of the UE-to-Network relay, the remote UE sends a Direct Communication Request to the relay UE for establishing a secure PC5 unicast link. The remote UE includes its security capabilities and security policy in the DCR message. The message also includes the SUCI, Relay Service Code and Nonce_1.
Step 1003: upon receiving the DCR message, the relay UE sends the relay key request to the relay AMF, including the parameters received in the DCR message.
Step 1004: the Relay AMF verifies whether the relay UE is authorized to act as an U2N relay.
Step 1005: the Relay AMF selects AUSF based on SUCI and forwards the key request to the AUSF in Nausf_UEAuthentication_Authenticate Request message. The relay AMF also includes the serving network name in the key request.
Steps 1006: if 5GPRUK ID is received from the relay AMF, the AUSF decides not to trigger authentication of UE and the AUSF discovers the PAnF based on the 5G PRUK ID. The AUSF sends a Npanf_Prose_AnchorKey_Get Request message to the PAnF. The 5G PRUK ID is included in this message.
Step 1007: if the PAnF cannot retrieve the Prose context information for the remote UE, the PAnF sends a response to AUSF.
Step 1008: the AUSF requests the remote UE's identity (SUCI) via the Relay AMF and the relay UE. The AUSF may also send a reject message to the remote UE, so the UE may use SUCI to retry steps 1002 to 1005, which is not shown in this figure.
Step 1009: the remote UE sends a response to the Remote AUSF including its identity (SUCI).
Step 1010: the AUSF retrieves the Authentication Vectors from the UDM via Nudm_UEAuthentication_GetProseAv Request message and triggers an authentication of the remote UE.
Step 1011: the Remote UDM de-conceals the SUCI and generates the AV.
Step 1012: the Remote AUSF receives a response from the Remote UDM comprising the Authentication Vectors (AV) from the UDM via Nudm_UEAuthentication_GetProseAV Response message.
Step 1013: the remote UE is authenticated. This authentication is performed between the AUSF and the remote UE via the relay AMF and relay UE. The AUSF does not make the newly derived K_{AUSF} as the latest K_{AUSF}. At the remote UE, the newly derived K_{AUSF} is not taken as the latest K_{AUSF} as the NAS SMC procedure is not performed between the remote UE and the relay AMF.
Step 1014a to 1014b: based on a successful primary authentication, the AUSF and remote UE may generate the 5GPRUK and 5GPRUK ID using the newly derived K_{AUSF}.
Step 1015: the AUSF sends the SUPI, 5GPRUK, 5GPRUK ID in Nausf_UEAuthentication_ProseAuthenticate Response message to the PAnF.
Step 1016: the PAnF stores the Prose context information (i.e., SUPI, 5GPRUK, 5GPRUK ID) for the remote UE and generates the Nonce_2 and the K_{NR_ProSe} key.
Step 1017 to 1019: the PAnF sends the K_{NR_ProSe} key and the Nonce_2 in Npanf_ProseKey_Response message to the UE-to-Network relay via the relay AMF. When receiving a K_{NR_ProSe} from the PAnF, via the AUSF, the AMF may not attempt to trigger the NAS SMC procedure with the remote UE. The relay UE derives the PC5 session key K_{relay-sess} and confidentiality and integrity keys from the K_{NR_ProSe}, using the KDF. The K_{NR_ProSe} ID and K_{relay-sess} ID are established in the same way as the K_{NRP} ID and the K_{NRP-sess} ID.
Step 1020: the UE-to-Network relay sends the received Nonce_2 to the remote UE in the Direct Security mode command message.
Step 1021: the remote UE generates the K_{NR_ProSe} key to be used for Remote access via the relay UE. The remote UE derives the PC5 session key K_{relay-sess} and confidentiality and integrity keys from the K_{NR_ProSe}
Step 1022: the remote UE sends the Direct Security mode complete message to the UE-to-Network relay.

Further communication between the remote UE and the Network takes place securely via the UE-to-Network relay.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a proximity service anchor function from a remote wireless communication terminal via a relay wireless communication terminal, a request for a key used for a communication between the remote wireless communication terminal and the relay wireless communication terminal, and the request comprising at least one of: a Proximity Remote User Key (PRUK) identifier, an identity of the remote wireless communication terminal, a relay service code, or a first nonce; and
transmitting, by the proximity service anchor function to the remote wireless communication terminal via the relay wireless communication terminal, a request for the identity of the remote wireless communication terminal or a reject message in response to the proximity service anchor node not being able to find a PRUK stored locally corresponding to the PRUK identifier or the proximity service anchor node determining to authenticate the remote wireless communication terminal.

2. The wireless communication method of claim 1, wherein the reject message comprises a value indicating a reject reason indicating the PRUK identifier of the remote wireless communication terminal being not found.

3. The wireless communication method of claim 1, wherein the proximity service anchor function receives a key request message including the identity of the remote wireless communication terminal after transmitting the reject message.

4. The wireless communication method of claim 1, wherein the identity of the remote wireless communication terminal comprises a Subscription Concealed Identifier (SUCI) of the remote wireless communication terminal.

5. A wireless communication method comprising:
receiving, by an authentication server function from a remote wireless communication terminal via a relay wireless communication terminal, a request for a key used for a communication between the remote wireless communication terminal and the relay wireless communication terminal, and the request comprising at least one of: a Proximity Remote User Key (PRUK) identifier, an identity of the remote wireless communication terminal, a relay service code, or a first nonce; and
transmitting, by the authentication server function to the remote wireless communication terminal via the relay wireless communication terminal, a request for the identity of the remote wireless communication terminal or a reject message in response to the authentication server function determining to authenticate the remote wireless communication terminal.

6. The wireless communication method of claim 5, wherein the reject message comprises a value indicating a reject reason indicating the PRUK identifier of the remote wireless communication terminal not found in a network.

7. The wireless communication method of claim 5, wherein the authentication server function receiving a key request message including the identity of the remote wireless communication terminal after transmitting the reject message.

8. The wireless communication method of claim 5, wherein the identity of the remote wireless communication terminal comprises a Subscription Concealed Identifier (SUCI) of the remote wireless communication terminal.

9. The wireless communication method of claim 5, wherein the authentication server function discovers a proximity service anchor function (PAnF) according to the PRUK identifier.

10. The wireless communication method of claim 8, wherein the authentication server function transmits the request for the key to a proximity service anchor function (PAnF) in response to the authentication server function skipping an authentication of the remote wireless communication terminal.

11. The wireless communication method of claim 10, wherein the authentication server function transmits, to the remote wireless communication terminal, the request for the identity of the remote wireless communication terminal or the reject message in response to receiving a response from the PAnF indicating that the PAnF is not able to retrieve the key.

12. A wireless communication method comprising:
transmitting, by a remote wireless communication terminal to a proximity service anchor function or an authentication server function, via a relay wireless communication terminal, a request for a key used for a communication between the remote wireless communication terminal and the relay wireless communication terminal, and the request comprising at least one of: a Proximity Remote User Key (PRUK) identifier, an identity of the remote wireless communication terminal, a relay service code, or a first nonce; and
receiving, by the remote wireless communication terminal from the proximity service anchor function or the authentication server function, via the relay wireless communication terminal, a request for the identity of the remote wireless communication terminal or a reject message in response to the proximity service anchor node not being able to find a PRUK stored locally corresponding to the PRUK identifier or the proximity service anchor node determining to authenticate the remote wireless communication terminal.

13. The wireless communication method of claim 12, wherein the reject message comprises a value indicating a reject reason indicating the remote wireless communication terminal to use the identity of the remote wireless communication terminal to request the key used for the communication between the remote wireless communication terminal and the relay wireless communication terminal.

14. The wireless communication method of claim 12, wherein the identity of the remote wireless communication terminal comprises a Subscription Concealed Identifier (SUCI) of the remote wireless communication terminal.

15. The wireless communication method of claim 12, wherein the remote wireless communication terminal transmits, to the proximity service anchor function or the authentication server function, a new request for the key comprising the identity of the remote wireless communication terminal according to the request for the identity of the remote wireless communication terminal or the reject message.
